(19) United States
(12) Patent Application Publication
(10) Pub. No.: US 2026/0250070 A1
(43) Pub. Date: Aug. 27, 2026

(54) STORAGE SYSTEM

(71) Applicant: Murata Machinery, Ltd., Kyoto-shi, Kyoto (JP)

(72) Inventor: Yasuhisa Ito, Kyoto-shi, Kyoto (JP)

(73) Assignee: Murata Machinery, Ltd., Kyoto-shi, Kyoto (JP)

(21) Appl. No.: 19/471,406

(22) PCT Filed: Mar. 5, 2024
(86) PCT No.: PCT/JP2024/008348

§ 371 Date: Oct. 1, 2025

(30) Foreign Application Priority Data
Apr. 5, 2023 (JP) 2023-061398

(51) Int. Cl. B65G 1/04; B65G 1/02; B65G 1/137; G06Q 10/087

(52) U.S. Cl. CPC B65G 1/0464; B65G 1/026; B65G 1/1371; G06Q 10/08743

(57) ABSTRACT

A storage system includes: a first communication device and a second communication device on an overhead transport vehicle; a third communication device capable of communicating with the first communication device; and a fourth communication device capable of communicating with the second communication device. The overhead transport vehicle transmits, to the fourth communication device via the second communication device, designation information for designating a movable shelf plate to which an article is to be transferred, and a storage device advances the designated movable shelf plate to a position where the article can be transferred. The overhead transport vehicle transfers the article to the movable shelf plate, already advanced to the position where the article can be transferred while performing communication processing for transferring the article to the designated movable shelf plate and the third communication device.

### CROSS REFERENCE TO RELATED APPLICATIONS

This application is a US national stage filing under 35 U.S.C. § 371 of International Application No. PCT/JP 2024/008348 filed Mar. 5, 2024, which claims priority to Japanese Patent Application No. 2023-061398, filed Apr. 5, 2023, each of which is incorporated herein by reference in its entirety.

### TECHNICAL FIELD

This disclosure relates to a storage system.

### BACKGROUND

For example, in a factory or the like that manufactures semiconductor products, an overhead transport vehicle that conveys articles along a rail provided on a ceiling may be used, and a storage device for temporarily storing the articles conveyed by the overhead transport vehicle may be provided. For example, Japanese Unexamined Patent Publication No. 62-297050 discloses a storage device (rack) installed on a floor. The storage device includes a plurality of movable shelf plates (slide shelves) that are advanced from a storage unit to positions where transfer from the transport vehicle is possible.

When the overhead transport vehicle transfers an article to the storage device, for example, the following operation is assumed to be executed. That is, the overhead transport vehicle starts interlock communication with the storage device, and transmits identification information of a shelf plate to which the article is to be transferred to the storage device. The storage device slides the shelf plate designated by the identification information to a transfer position where the overhead transport vehicle can transfer the article, and transmits completion information indicating that the article can be transferred to the overhead transport vehicle. Upon receiving the completion information, the overhead transport vehicle continues the interlock communication and transfers the article.

However, in the storage system including the overhead transport vehicle and the storage device as described above, the execution of the interlock communication and the communication for the shelf plate designation are simultaneously performed, and thus the amount of information that can be used for the shelf plate designation is limited. Therefore, the number of installed movable shelf plates that can be transferred from the overhead transport vehicle stopped at a predetermined position is limited.

It could therefore be helpful to provide a storage system capable of increasing the number of installed movable shelf plates that can be transferred from an overhead transport vehicle stopped at a predetermined position.

### SUMMARY

Disclosed herein is:

A storage system includes an overhead transport vehicle configured to convey an article along a track provided on a ceiling, a storage device provided with a plurality of movable shelf plates onto which the article can be transferred by the overhead transport vehicle stopped at a predetermined position in the track and which are arranged in a vertical direction, a first communication device provided in the overhead transport vehicle; a second communication device provided in the overhead transport vehicle, a third communication device capable of communicating with the first communication device, and a fourth communication device capable of communicating with the second communication device, wherein the overhead transport vehicle transmits designation information for designating the movable shelf plate to which the article is to be transferred to the fourth communication device via the second communication device, the storage device advances the movable shelf plate designated by the designation information received via the fourth communication device to a position where the article can be transferred by the overhead transport vehicle, and the overhead transport vehicle transfers the article to the movable shelf plate which has been advanced to the position where the article can be transferred while performing communication processing for transferring the article to the movable shelf plate designated by the designation information between the first communication device and the third communication device.

In the storage system having this configuration, the communication device (the second communication device and the fourth communication device) for communicating the designation information for designating the movable shelf plate to which the article is to be transferred and the communication device (the first communication device and the third communication device) for performing the communication processing for transferring the article to the movable shelf plate designated by the designation information are different from each other. As a result, the second communication device and the fourth communication device do not need to perform the communication processing for transferring, and thus the amount of information for designating the movable shelf plate can also be increased. As a result, the number of the movable shelf plates to which the article can be transferred from the overhead transport vehicle stopped at the predetermined position can be increased.

The third communication device may be provided on the track to be capable to communicate with the first communication device of the overhead transport vehicle stopped at the predetermined position, and the fourth communication device may be provided on the track to be capable to communicate with the second communication device of the overhead transport vehicle stopped at the predetermined position. This configuration enables reliable communication between the overhead transport vehicle stopped at the predetermined position and the third communication device and between the overhead transport vehicle stopped at the predetermined position and the fourth communication device.

The storage device may advance the movable shelf plate designated by the designation information received via the fourth communication device to the position where the article can be transferred by the overhead transport vehicle, and transmit a response signal via the third communication device, and the overhead transport vehicle may start transferring the article to the movable shelf plate when receiving the response signal via the first communication device. In this configuration, the overhead transport vehicle can transfer the article after confirming that the article can be transferred.

The storage device may transmit information on the advanced movable shelf plate together with the response signal via the fourth communication device, the overhead transport vehicle may determine whether or not the movable shelf plate specified by the designation information transmitted via the second communication device and the movable shelf plate specified by the information on the movable shelf plate received via the second communication device match with each other, and when the overhead transport vehicle determines that the movable shelf plates match with each other, the overhead transport vehicle may start transferring the article to the movable shelf plate determined to match, and when the overhead transport vehicle determines that the movable shelf plates do not match with each other, the overhead transport vehicle may not start transferring the article to the movable shelf plate even if the overhead transport vehicle receives the response signal. In this configuration, when the overhead transport vehicle determines that the movable shelf plates do not match with each other by the communication between the second communication device and the fourth communication device, the transfer can be stopped even if the communication between the first communication device and the third communication device proceeds normally.

The overhead transport vehicle may include a gripping unit that grips the article and an elevation unit that raises and lowers the gripping unit, the storage devices may be disposed on a side of the track along the track in plan view, and be disposed in pairs to face each other with an elevation region of the gripping unit interposed therebetween, and the movable shelf plate may be configured to be able to be advanced to the elevation region. In this configuration, the number of the movable shelf plates that can be installed can be efficiently increased, and the overhead transport vehicle can transfer the article only by elevating and lowering the gripping unit without laterally feeding the gripping unit, so that a time required for transferring can be shortened.

The number of the movable shelf plates that can be transferred from the overhead transport vehicle stopped at the predetermined position can be increased.

### BRIEF DESCRIPTION OF THE DRAWINGS

FIG. 1 is a schematic plan view illustrating a carrier system.

FIG. 2 is a front view of a carrier in FIG. 1 as viewed from the front.

FIG. 3 is a front view of a first storage shelf and a second storage shelf in FIG. 1 as viewed from the front.

FIG. 4 is a side view of the first storage shelf and the second storage shelf in FIG. 1 as viewed from the side.

FIG. 5A is a detailed plan view of a movable shelf plate. FIG. 5B is a detailed front view of the movable shelf plate.

FIG. 6 is a sequence diagram illustrating an example of an operation of the carrier and the storage shelf when an article is transferred from the carrier to the storage shelf.

### REFERENCE SIGNS LIST

1 storage system
4 track
6 overhead transport vehicle (transport vehicle)
10 article
30 elevation stage (elevation unit)
39A first communication device
39B second communication device
40 storage shelf
40A first storage shelf
40B second storage shelf (storage device)
50 main body
51 storage unit
52 partition plate
53 movable shelf plate
54 placement unit
80A third communication device
80B fourth communication device
C ceiling
G floor surface
S elevation region

### DETAILED DESCRIPTION

Hereinafter, a storage shelf and a carrier system including the storage shelf will be described with reference to the drawings. In description of the drawings, the same elements are denoted by the same reference numerals, and redundant description will be omitted.

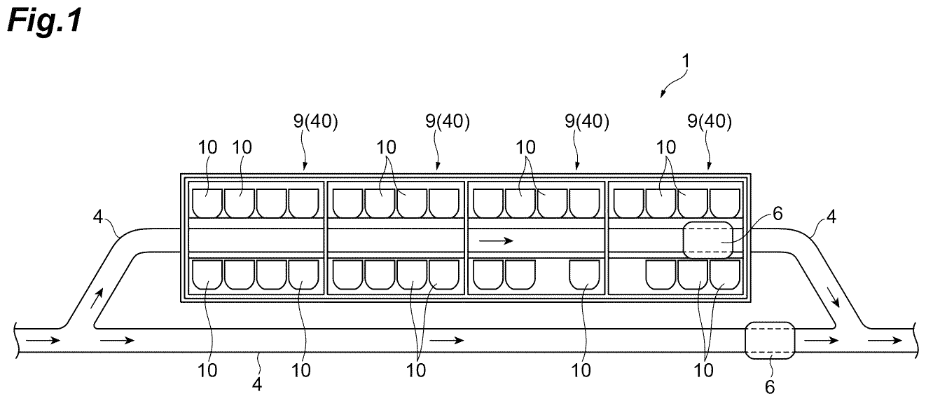

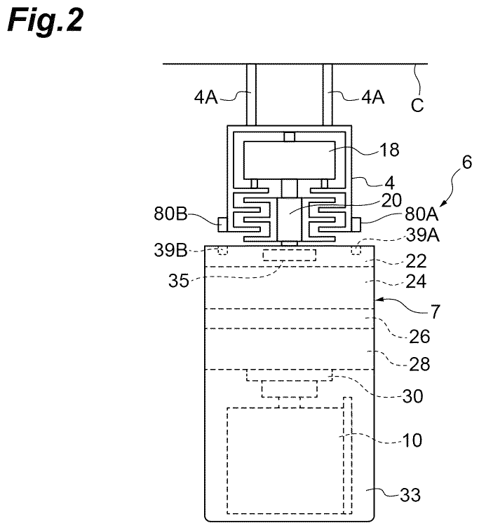

As illustrated in FIGS. 1 and 2, a storage system 1 is a system for conveying an article 10 between placement units 9 and 9 using, for example, an overhead transport vehicle (carrier) 6 movable along a track 4. Examples of the article 10 include containers such as a front opening unified pod (FOUP) storing a plurality of semiconductor wafers and a reticle pod container storing a glass substrate, and common parts. For example, in a factory or the like, the storage system 1 in which the overhead transport vehicle 6 (hereinafter, simply referred to as “transport vehicle 6”) travels along the one-way track 4 laid on a ceiling C or the like of the factory will be described as an example. As illustrated in FIG. 1, the storage system 1 includes the track 4, the placement units 9, and the plurality of carriers 6.

The track 4 is laid, for example, in the vicinity of the ceiling C that is a space above a worker's head. In this embodiment, the track 4 is provided on the ceiling C. The track 4 may be directly provided on the ceiling C, or may be indirectly provided on the ceiling C with another member interposed therebetween. The track 4 is suspended via a support column 4A fixed to the ceiling C. The track 4 is a predetermined traveling path for causing the carriers 6 to travel.

Each transport vehicle 6 travels along the track 4 and conveys the article 10. The transport vehicle 6 is configured to be able to transfer the article 10. The transport vehicle 6 is a ceiling traveling-type unmanned carrier. The number of the carriers 6 included in the storage system 1 is not particularly limited, and is more than one. Each transport vehicle 6 includes a main body 7, a traveling unit 18, and a control unit 35.

The main body 7 includes a main body frame 22, a lateral feed unit 24, a θ drive 26, an lifting drive unit 28, an elevation stage (elevation unit) 30, and a fall prevention cover 33. The traveling unit 18 includes a motor or the like, and causes the transport vehicle 6 to travel along the track 4. The traveling unit 18 includes, for example, a power receiving communication unit 20 that receives power from the track 4 side by contactless power transfer.

The lateral feed unit 24 laterally feeds the θ drive 26, the lifting drive unit 28, and the elevation stage 30 collectively in a direction orthogonal to the traveling direction of the track 4. The θ drive 26 turns at least one of the lifting drive unit 28 and the elevation stage 30 within a predetermined angle range in a horizontal plane. The lifting drive unit 28 raises and lowers the elevation stage 30 by reeling or unreeling a suspension member such as a wire, a rope, and a belt. The elevation stage 30 is provided with a chuck (gripping unit) and can freely grip or release the article 10. A pair of the fall prevention covers 33 is provided, for example, in the front and rear of the transport vehicle 6 in the traveling direction. The fall prevention cover 33 causes not-illustrated claws or the like to project and withdraw below the article 10 to be conveyed, thereby preventing the article 10 from falling during conveyance.

The control unit 35 is an electronic control unit including a central processing unit (CPU), a read only memory (ROM), and a random access memory (RAM) or the like. The control unit 35 controls various operations in the transport vehicle 6. Specifically, the control unit 35 controls the traveling unit 18, the lateral feed unit 24, the θ drive 26, the lifting drive unit 28, and the elevation stage 30. The control unit 35 can be configured, for example, as software that is a program stored in the ROM, loaded into the RAM, and executed by the CPU. The control unit 35 may be configured as hardware with an electronic circuit or the like.

The placement units 9 each are disposed along the track 4 and provided at a position where the article 10 can be delivered to and from the transport vehicle 6. The placement units 9 each include a buffer and a delivery port. On the buffer, the article 10 is temporarily placed. In the buffer, the article 10 is temporarily placed when the article 10 carried by the transport vehicle 6 cannot be transferred to a target delivery port, for example, for the reason that another article 10 has been placed on the target delivery port. Examples of the placement unit 9 include a storage shelf 40. The delivery port is, for example, a placement unit for delivering the article 10 to and from a semiconductor processing device (not illustrated) such as a cleaning device, a deposition device, a lithography device, an etching device, a thermal treatment device, and a planarization device. The processing device is not particularly limited, and may be a variety of devices.

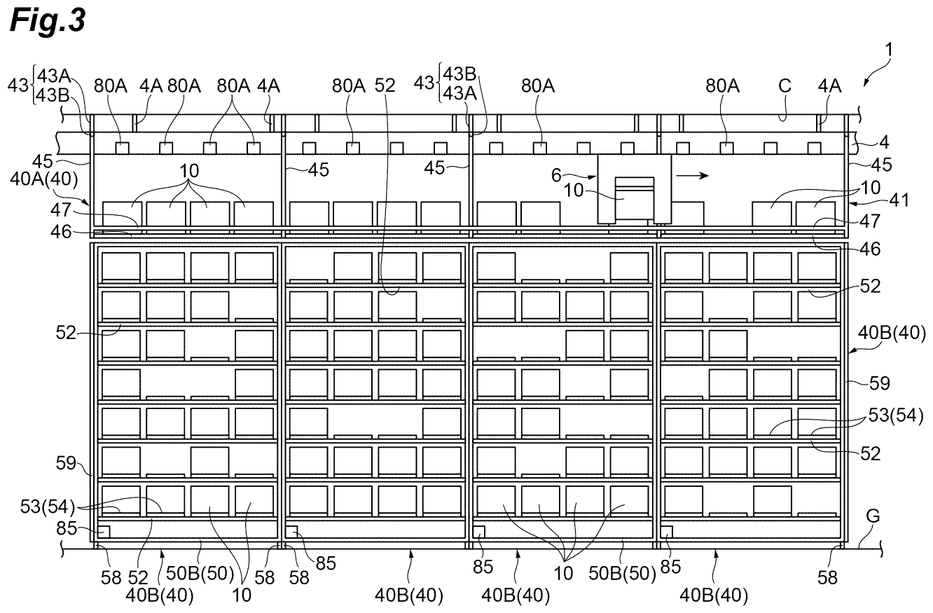

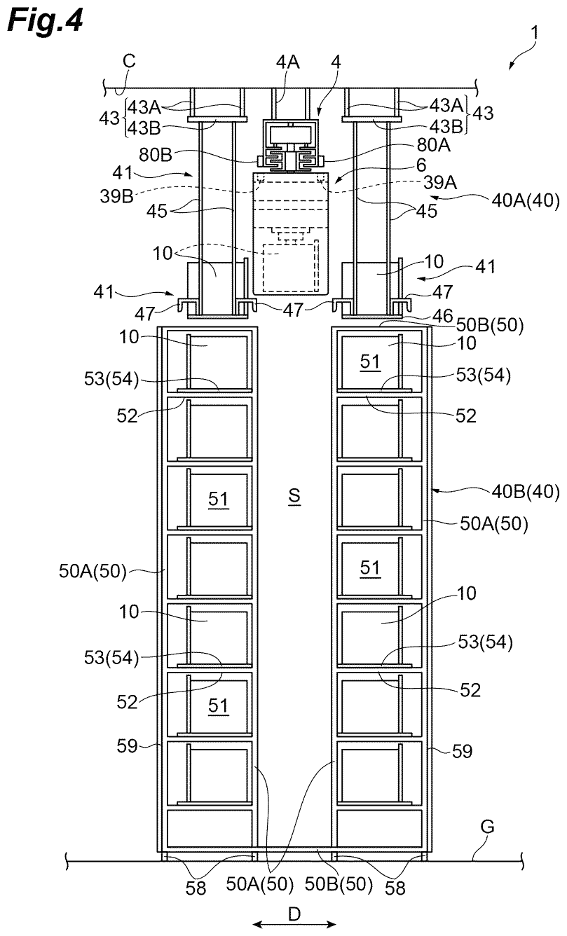

As illustrated in FIGS. 3 and 4, the storage shelf 40 includes a first storage shelf 40A and a second storage shelf (storage device) 40B. The first storage shelf 40A is suspended from a ceiling C of a building in which the storage shelf 40 is installed. The second storage shelf 40B is disposed below the first storage shelf 40A, and is installed on a floor surface of a building in which the storage shelf 40 is installed.

The first storage shelf 40A is disposed on both sides of the track 4 (traveling area of the transport vehicle 6 traveling on the track 4) in plan view to sandwich the track 4. The first storage shelf 40A includes a suspended storage unit 41 and a suspended unit 45. The suspended storage unit 41 is a portion that stores the article 10. The suspended storage unit 41 includes a fixed shelf plate 46 and a fall prevention fence 47. The fixed shelf plate 46 supports the article 10 from below. The fixed shelf plate 46 of this embodiment supports four articles 10. The fixed shelf plate 46 is immovably attached to the suspended unit 45. The fall prevention fence 47 is disposed on the side of the article 10 supported by the fixed shelf plate 46, and prevents the article 10 from falling from the fixed shelf plate 46. The fall prevention fence 47 extends along the track 4.

The suspended unit 45 is suspended from the ceiling C of the building in which the first storage shelf 40A is installed via an attachment unit 43. The suspended units 45 are disposed at equal intervals along the extending direction of the track 4. The attachment unit 43 includes a fixing unit 43A and a support unit 43B attached to the ceiling C. The suspended unit 45 extends downward from the support unit 43B. The transfer of the article from the transport vehicle 6 to the first storage shelf 40A as described above is performed by laterally feeding the lifting drive unit 28 or the like by the lateral feed unit 24 and elevating and lowering the elevation stage 30.

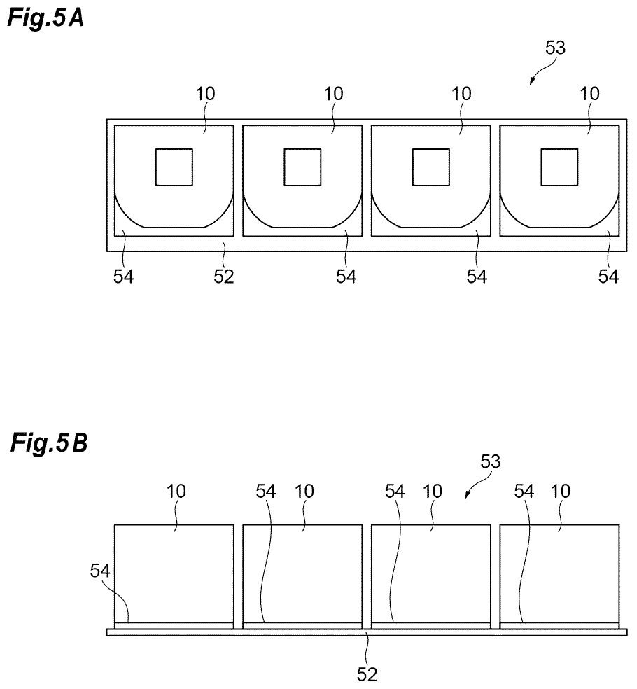

As illustrated in FIGS. 3 to 5, the second storage shelf 40B is disposed below the first storage shelf 40A. The second storage shelf 40B includes a support column 50A, a frame 50B, a storage unit 51, a leg unit 58, a main body panel 59, and a control device 85. The second storage shelves 40B as described above are arranged in the extending direction of the track 4. More specifically, the second storage shelves 40B are disposed on the side of the track 4 along the track 4 in plan view, and are disposed in pairs to face each other with the elevation region S of the elevation stage (gripping unit) 30 interposed therebetween.

The support columns 50A are members extending in the vertical direction, and are disposed at four corners of the second storage shelf 40B. The frame 50B is fixed to the upper end and the lower end of the four support columns 50A. The storage unit 51 is a portion for storing the article 10, and includes a partition plate 52 and a movable shelf plate 53. The plurality of partition plates 52 are arranged along the vertical direction. In this embodiment, the seven partition plates 52 are disposed (in seven stages) along the vertical direction.

The movable shelf plate 53 is disposed on the upper surface of the partition plate 52. The four movable shelf plates 53 are arranged on the upper surface of one partition plate 52 in the extending direction of the track 4. The movable shelf plate 53 includes a placement unit 54, a guide unit (not illustrated), and a drive unit (not illustrated).

The placement unit 54 is provided to be movable in a width direction orthogonal to both the extending direction of the track 4 and the vertical direction with respect to the partition plate 52. The placement unit 54 supports and holds the article 10 from below. A positioning member for positioning the article 10 may be disposed on the upper surface of the placement unit 54. The placement unit 54 is formed to have the same size as that of the article 10 or a size larger than that of the article 10 in plan view.

The guide units are provided to be disposed on both sides of the respective placement units 54 in the arrangement direction of the movable shelf plates 53. The guide unit guides the movement of the placement unit 54 in the width direction. The drive unit is a drive source for moving the placement unit 54 in the width direction, and is, for example, a motor, a cylinder, or the like. The driving of the drive unit is controlled by the control device 85.

The leg unit 58 is provided on the frame 50B provided at the lower end of the four support columns 50A, and a main body 50 is installed on the floor surface G of the building. The main body panel 59 is a plate-shaped member that covers a back surface of the second storage shelf 40B (surfaces opposite to surfaces of the pair of second storage shelves 40B facing each other) and a side surface of the second storage shelf 40B (a surface orthogonal to the traveling direction of the transport vehicle 6). In FIG. 3, the illustration of the main body panel 59 along the extending direction of the track 4 in the main body panels 59 attached to surround the side of the main body 50 is omitted. In FIG. 4, the display of the main body panel 59 is omitted. The control device 85 controls the driving of the drive unit of the movable shelf plate 53. The control device 85 is provided, for example, at a lower portion of the second storage shelf 40B. An example in which the control device 85 is provided for each of the second storage shelves 40B has been described. However, the control device may be configured to collectively control the drive units disposed in the plurality of second storage shelves 40B.

As described above, in the second storage shelf 40B, the movable shelf plates 53 are arranged in both the vertical direction and the extending direction of the track 4. Hereinafter, the arrangement of the movable shelf plates 53 (placement units 54) in the traveling direction of the transport vehicle 6 of the second storage shelf 40B will be described as “series”, and the arrangement of the movable shelf plates 53 (placement units 54) in the vertical direction will be described as “stage”.

The transfer of the article from the transport vehicle 6 to the second storage shelf 40B is performed by advancing the placement unit 54 including the placement position of the conveyance destination or the conveyance source to the elevation region S by a command from the transport vehicle 6, and then elevating and lowering the elevation stage 30. A configuration enabling such control will be described below.

As illustrated in FIG. 2, the transport vehicle 6 includes a first communication device 39A and a second communication device 39B that enable communication with the second storage shelf 40B. As illustrated in FIGS. 2 and 3, the track 4 includes a third communication device 80A capable of communicating with the first communication device 39A and a fourth communication device 80B capable of communicating with the second communication device 39B. The third communication device 80A and the fourth communication device 80B are disposed to correspond to each of the series of the second storage shelves 40B in the extending direction of the track 4 (the traveling direction of the transport vehicle 6). More specifically, the third communication device 80A and the fourth communication device 80B are disposed on the outer side surface of the track 4 to be positioned above each series. The first communication device 39A, the second communication device 39B, the third communication device 80A, and the fourth communication device 80B may be parallel interfaces (E84 sensors) based on the SEMI standard.

The third communication device 80A provided above the predetermined series is provided to be capable to communicate only with the first communication device 39A stopped above the predetermined series based on a conveyance command transmitted from a host controller that controls the plurality of carriers 6 constituting the storage system 1. The third communication device 80A can transmit and receive signals only to and from the first communication device 39A. Similarly to the third communication device 80A, the fourth communication device 80B provided above the predetermined series is also provided to be capable to communicate only with the second communication device 39B stopped above the predetermined series based on the conveyance command transmitted from the host controller that controls the plurality of carriers 6 constituting the storage system 1. The fourth communication device 80B can transmit and receive signals only to and from the second communication device 39B.

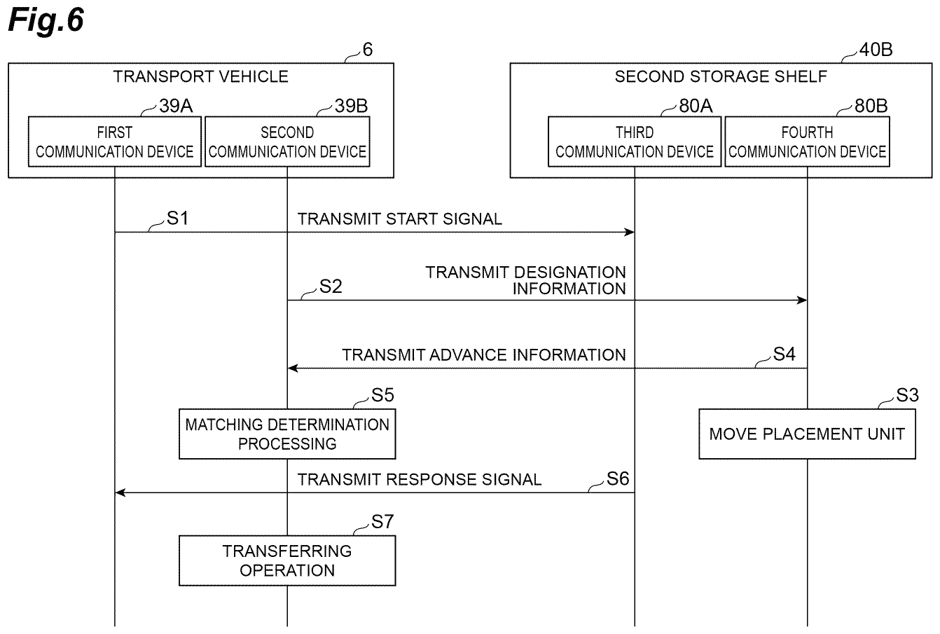

In such a configuration, the operations of the transport vehicle 6 and the second storage shelf 40B when transferring (placing) the article 10 from the transport vehicle 6 to the second storage shelf 40B will be described with reference to FIG. 6. The transport vehicle 6 moves to and stops at a destination (above a predetermined series in the second storage shelf 40B including the placement unit 54 as a conveyance destination) based on a conveyance command transmitted from a host controller (not illustrated) that controls the plurality of carriers 6 constituting the storage system 1. Next, the control unit 35 of the transport vehicle 6 starts communication processing (for example, an SEMI E84 standard interlock sequence) for transferring the article 10 to the placement unit 54. The control unit 35 of the transport vehicle 6 transmits a start signal to the third communication device 80A via the first communication device 39A (step S1). Next, the control unit 35 of the transport vehicle 6 transmits designation information (for example, shelf number) for specifying the placement unit 54 as the transfer destination included in the conveyance command to the fourth communication device 80B via the second communication device 39B (step S2).

When receiving the designation information via the fourth communication device 80B, the control device 85 of the second storage shelf 40B controls the drive unit to advance the placement unit 54 designated by the designation information to the position (elevation region S) where the article 10 can be transferred by the transport vehicle 6. As a result, the placement unit 54 is advanced to the position (elevation region S) where the article 10 can be transferred by the transport vehicle 6 (step S3). The control device 85 of the second storage shelf 40B transmits information on the advanced placement unit 54 (hereinafter, also referred to as “advance information”) to the second communication device 39B via the fourth communication device 80B (step S4). An example of the advance information is information (for example, shelf number) that can specify the advanced placement unit 54.

Upon receiving the advance information via the second communication device 39B, the control unit 35 of the transport vehicle 6 determines whether or not to start transferring the article 10 to the placement unit 54. Specifically, the control unit 35 of the transport vehicle 6 determines whether or not the placement unit 54 specified by the designation information transmitted via the second communication device 39B and the placement unit 54 specified by the advance information received via the second communication device 39B match with each other (hereinafter, also referred to as “matching determination processing”) (step S5).

The control device 85 of the second storage shelf 40B that has received the start signal via the third communication device 80A transmits a response signal to the first communication device 39A via the third communication device 80A (step S6). When the control unit 35 of the transport vehicle 6 determines in step S5 that the placement units 54 match with each other, the control unit 35 of the transport vehicle 6 that has received the response signal in step S6 starts transferring the article 10 to the placement unit 54 determined to match, and when the control unit 35 of the transport vehicle 6 determines that the placement units do not match with each other, the control unit does not start transferring the article 10 to the placement unit 54 even if the response signal is received via the first communication device 39A in step S6 (step S7).

When the control unit 35 of the transport vehicle 6 determines that the placement units 54 do not match with each other, the control unit 35 of the transport vehicle 6 may notify an operator of the determination. When the control unit 35 of the transport vehicle 6 determines that the placement units 54 do not match with each other, the control unit 35 of the transport vehicle 6 may transmit an error signal via the second communication device 39B. When receiving the error signal via the fourth communication device 80B, the control device 85 of the second storage shelf 40B may notify the operator of the reception of the error signal.

When starting transferring the article 10 to the placement unit 54, the control unit 35 of the transport vehicle 6 transfers the article 10 to the placement unit 54 advanced to the position where the article 10 can be transferred while performing communication processing for transferring the article 10 to the placement unit 54 designated by the designation information (for example, based on the execution of an SEMI E84 standard interlock sequence) between the first communication device 39A and the third communication device 80A. The control unit 35 of the transport vehicle 6 raises and lowers the elevation stage 30 with respect to the placement unit 54 that has been advanced to the elevation region S to transfer the article 10.

The functions and effects of the storage system 1 will be described. The communication device (the second communication device 39B and the fourth communication device 80B) for communicating the designation information for designating the placement unit 54 to which the article 10 is to be transferred and the communication device (the first communication device 39A and the third communication device 80A) for repeating the communication processing for transferring the article 10 to the placement unit 54 designated by the designation information are different from each other. As a result, the second communication device 39B and the fourth communication device 80B do not need to perform the communication processing for transferring to the placement unit 54, and thus the amount of information for designating the placement unit 54 can also be increased. As a result, the number of the installed placement units 54 to which the article can be transferred from the transport vehicle 6 stopped at the predetermined position can be increased.

The third communication device 80A is provided on the track 4 to be capable to communicate with the first communication device 39A of the transport vehicle 6 stopped at the predetermined position, and the fourth communication device 80B is provided on the track 4 to be capable to communicate with the second communication device 39B of the transport vehicle 6 stopped at the predetermined position. This enables reliable communication between the transport vehicle 6 stopped at the predetermined position and the third communication device 80A, and between the transport vehicle 6 stopped at the predetermined position and the fourth communication device 80B.

The control device 85 of the second storage shelf 40B advances the placement unit 54 designated by the designation information received via the fourth communication device 80B to the position where the article 10 can be transferred by the transport vehicle 6 and transmits a response signal via the fourth communication device 80B, and when receiving the response signal via the second communication device 39B, the control unit 35 of the transport vehicle 6 starts transferring the article 10 to the placement unit 54. As a result, the transport vehicle 6 can transfer the article 10 after confirming that the article can be transferred.

The control device 85 of the second storage shelf 40B transmits the advance information together with the response signal via the fourth communication device 80B, and the control unit 35 of the transport vehicle 6 determines whether the placement unit 54 specified by the designation information transmitted via the second communication device 39B and the placement unit 54 specified by the advance information received via the second communication device 39B match with each other. When the control unit 35 determines that the placement units 54 match with each other, the control unit 35 starts transferring the article 10 to the placement unit 54 determined to match. When the control unit 35 determines that the placement units 54 do not match with each other, the control unit 35 does not start transferring the article 10 to the placement unit 54 even if the response signal is received. In this configuration, when it is determined that the placement units 54 do not match with each other by the communication between the second communication device 39B and the fourth communication device 80B, the transfer can be stopped even if the communication between the first communication device 39A and the third communication device 80A proceeds normally.

The second storage shelves 40B are disposed on the side of the track 4 along the track 4 in plan view, and are disposed in pairs so as to face each other with the elevation region S interposed therebetween. The placement unit 54 is configured to be able to be advanced to the elevation region S. As a result, the number of the placement units 54 that can be installed can be efficiently increased, and the transport vehicle 6 can transfer the article 10 only by elevating and lowering the elevation stage 30, so that a time required for transferring can be shortened.

Although one embodiment has been described above, this disclosure is not limited to the above embodiment. Various modifications can be made without departing from the gist of the amended claims.

An example in which the control device 85 of the second storage shelf 40B transmits the advance information via the fourth communication device 80B when receiving the designation information via the fourth communication device 80B has been described, but is not limited thereto. For example, when receiving the designation information via the fourth communication device 80B, the control device 85 of the second storage shelf 40B may advance the placement unit 54 specified by the designation information without transmitting the advance information.

In the storage system 1 of the above embodiment and the above modification, an example has been described in which when receiving the response signal and the advance information, the control unit 35 of the transport vehicle 6 determines whether or not to start transferring the article 10 to the placement unit 54 that has been advanced to the position where the article can be transferred based on the determination result by the matching determination processing. However, the matching determination processing may be omitted, and the transfer of the article 10 may be started.

In the storage system 1 of the above embodiment and the above modification, an example in which the third communication device 80A and the fourth communication device 80B are disposed on the side surface of the track 4 has been described, but is not limited thereto. For example, the third communication device 80A may be disposed to correspond to each series on the top surface or the like of the second storage shelf 40B to be capable to communicate with the first communication device 39A of the transport vehicle 6 stopped at the predetermined position. For example, the fourth communication device 80B may be disposed to correspond to each series on the top surface or the like of the second storage shelf 40B to be capable to communicate with the second communication device 39B of the transport vehicle 6 stopped at the predetermined position.

In the storage system 1 of the above embodiment and the above modification, an example in which the first storage shelf 40A is provided has been described, but the first storage shelf 40A may not be provided. An example in which the storage shelf on which the movable shelf plate 53 is provided is installed on the floor surface G has been described, but the storage shelf may be configured as a storage shelf installed on the ceiling C in a suspended state.

In the storage system 1 of the above embodiment and the above modification, an example in which all the placement units 54 constituting the second storage shelf 40B are configured to be movable has been described. However, a part of the placement units 54 constituting the second storage shelf 40B may be a stationary fixed shelf.

In the storage system 1 of the above embodiment and the above modification, an example in which the movable shelf plates 53 are arranged in seven stages in the vertical direction has been described. However, the number of the stages is not limited to such a number, and the number of the stages may be less than seven, or may be eight or more. The number of the second storage shelves 40B disposed along the extending direction of the track 4 is also not limited to four. It is not essential that the second storage shelves 40B are disposed in pairs to face each other with the elevation region S interposed therebetween, and the second storage shelves 40B may be disposed along only one side of the elevation region S.

The technical subject matter of one aspect may be described as follows.
[1] A storage system including: an overhead transport vehicle configured to convey an article along a track provided on a ceiling; a storage device provided with a plurality of movable shelf plates onto which the article can be transferred by the overhead transport vehicle stopped at a predetermined position in the track and which are arranged in a vertical direction; a first communication device provided in the overhead transport vehicle; a second communication device provided in the overhead transport vehicle; a third communication device capable of communicating with the first communication device; and a fourth communication device capable of communicating with the second communication device, wherein the overhead transport vehicle transmits designation information for designating the movable shelf plate to which the article is to be transferred to the fourth communication device via the second communication device, the storage device advances the movable shelf plate designated by the designation information received via the fourth communication device to a position where the article can be transferred by the overhead transport vehicle, and the overhead transport vehicle transfers the article to the movable shelf plate which has been advanced to the position where the article can be transferred while performing communication processing for transferring the article to the movable shelf plate designated by the designation information between the first communication device and the third communication device.
[2] The storage system according to [1], wherein the third communication device is provided on the track to be capable to communicate with the first communication device of the overhead transport vehicle stopped at the predetermined position, and the fourth communication device is provided on the track to be capable to communicate with the second communication device of the overhead transport vehicle stopped at the predetermined position.
[3] The storage system according to [1] or [2], wherein the storage device advances the movable shelf plate designated by the designation information received via the fourth communication device to the position where the article can be transferred by the overhead transport vehicle, and transmits a response signal via the third communication device, and the overhead transport vehicle starts transferring the article to the movable shelf plate when receiving the response signal via the first communication device.
[4] The storage system according to [3], wherein the storage device transmits information on the advanced movable shelf plate via the fourth communication device, the overhead transport vehicle determines whether or not the movable shelf plate specified by the designation information transmitted via the second communication device and the movable shelf plate specified by the information on the movable shelf plate received via the second communication device match with each other, and when the overhead transport vehicle determines that the movable shelf plates match with each other, the overhead transport vehicle starts transferring the article to the movable shelf plate determined to match, and when the overhead transport vehicle determines that the movable shelf plates do not match with each other, the overhead transport vehicle does not start transferring the article to the movable shelf plate even if the overhead transport vehicle receives the response signal.
[5] The storage system according to any one of [1] to [4], wherein the overhead transport vehicle includes a gripping unit that grips the article and an elevation unit that raises and lowers the gripping unit, the storage devices are disposed on a side of the track along the track in plan view, and are disposed in pairs to face each other with an elevation region of the gripping unit interposed therebetween, and the movable shelf plate is configured to be able to be advanced to the elevation region.

What is claimed is:

1. A storage system comprising:
an overhead transport vehicle configured to convey an article along a track provided on a ceiling;
a storage device provided with a plurality of movable shelf plates onto which the article can be transferred by the overhead transport vehicle stopped at a predetermined position in the track and which are arranged in a vertical direction;
a first communication device provided in the overhead transport vehicle;
a second communication device provided in the overhead transport vehicle;
a third communication device capable of communicating with the first communication device; and
a fourth communication device capable of communicating with the second communication device,
wherein
the overhead transport vehicle transmits designation information for designating the movable shelf plate to which the article is to be transferred to the fourth communication device via the second communication device,
the storage device advances the movable shelf plate designated by the designation information received via the fourth communication device to a position where the article can be transferred by the overhead transport vehicle, and
the overhead transport vehicle transfers the article to the movable shelf plate which has been advanced to the position where the article can be transferred while performing communication processing for transferring the article to the movable shelf plate designated by the designation information between the first communication device and the third communication device.

2. The storage system according to claim 1, wherein
the third communication device is provided on the track to be capable to communicate with the first communication device of the overhead transport vehicle stopped at the predetermined position, and
the fourth communication device is provided on the track to be capable to communicate with the second communication device of the overhead transport vehicle stopped at the predetermined position.

3. The storage system according to claim 1, wherein
the storage device advances the movable shelf plate designated by the designation information received via the fourth communication device to the position where the article can be transferred by the overhead transport vehicle, and transmits a response signal via the third communication device, and
the overhead transport vehicle starts transferring the article to the movable shelf plate when receiving the response signal via the first communication device.

4. The storage system according to claim 3, wherein
the storage device transmits information on the advanced movable shelf plate via the fourth communication device,
the overhead transport vehicle determines whether or not the movable shelf plate specified by the designation information transmitted via the second communication device and the movable shelf plate specified by the information on the movable shelf plate received via the second communication device match with each other, and
when the overhead transport vehicle determines that the movable shelf plates match with each other, the overhead transport vehicle starts transferring the article to the movable shelf plate determined to match, and when the overhead transport vehicle determines that the movable shelf plates do not match with each other, the overhead transport vehicle does not start transferring the article to the movable shelf plate even if the overhead transport vehicle receives the response signal.

5. The storage system according to claim 1, wherein
the overhead transport vehicle includes a gripping unit that grips the article and an elevation unit that raises and lowers the gripping unit,
the storage devices are disposed on a side of the track along the track in plan view, and are disposed in pairs so as to face each other with an elevation region of the gripping unit interposed therebetween, and
the movable shelf plate is configured to be able to be advanced to the elevation region.
